(19) United States
(12) Patent Application Publication
(10) Pub. No.: US 2002/0089182 A1
(43) Pub. Date: Jul. 11, 2002

(54) S.G.S. Genset

(76) Inventor: K. A. Nagaraja Gurikar, Davangere (IN)

Correspondence Address: K. A. NAGARAJA, Janatha lodge, Poona-Bangalore Road, DAVANGERE, KARNATAKA, 577 002, IN

(21) Appl. No.: 09/757,091

(22) Filed: Jan. 10, 2001

(51) Int. Cl. H02P 9/00; H02P 9/04

(52) U.S. Cl. 290/1 R

(57) ABSTRACT

S.G.S. Genset is an electrical energy producer generator. According to the plan of the generator, it does not need any kind of fuel consumption. It does not produce air pollution, sound pollution, and it works in any place, and also in any weather condition.

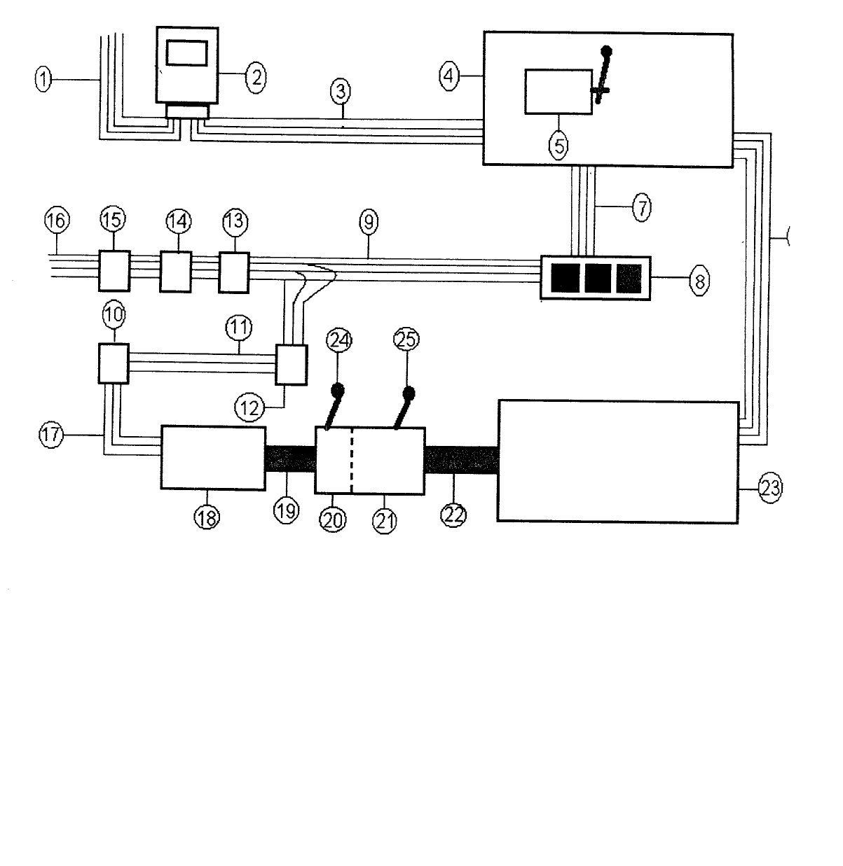

### DESCRIPTION

First start the Generator Motor from the power supply. Then change the gear upto the Generator alternator rotating as its speed level. When it rotates at its speed then change the power supply from electric power line to the Generator alternator line. From this method the Generator power supply will return to the Generator Motor through UPS capable of rotating the generator Motor, during the changing time. From this motor rotates continuously

When the output power load of the Generator increases, its rotation speed level decreases. So the gear has to be raised to the required (volts) speed level.

### FOR EXAMPLE

The Generator Motor should be of 25 H.P capacity and the Generator alternator should be 200 H.P capacity. From the 200 H.P. energy from the alternator, 25% consumption is used to the Generator Motor. The remaining 75% of energy will he useful for extra lighting and motor purpose.

From this plan we can save the power, cooking gas and other fuel consumption. This plan is useful to run ships, trains, submarines and Airplanes. This is my opinion of the result.

### DETAILS OF THE DEVICES USED

1. Wire from the power pole to the Meter.

2. Power Meter (Electric Meter)

3. Wire from the meter to the Generator changing Box.

4. Generator changing Box.

5. Generator changing Switch.

6. Wire from the Generator alternator to the changing box.

7. Wire from Generator changing Box to the Main Fuse Box.

8. Main Fuse Box.

9. Wires connected to the starter and lighting from the Fuse Box.

10. Motor starter to rotate the Generator Motor.

11. Wire from UPS to the starter.

12. UPS

13. Extra Starters.

14. Extra Starters.

15. Extra Starters.

16. Wire for extra lighting

17. Wire from starter to the generator Motor.

18. Motor capable of rotating the alternator

19. Connection rod.

20. Clutch box.

21. Gear box to change the gears.

22. Connection rod.

23. Alternator of the generator.

24. Clutch box rod.

25. Gear box rod.

1. The other Generator manufacturers should not use the Motor, Gearbox and clutch Box in any models, and in any kind or types.

2. If any one wants to manufacture generator or any such kinds with my basic Generator plan, they should obtain my permission.

3. If any one can go to use my Generator's basic plan in their re-models, or going to sale to other persons, and if the purchaser also deals the business through myself, each party should pay 15% of the sales amount in all kind of further dealings.
